(19) United States
(12) Patent Application Publication
(10) Pub. No.: US 2015/0160485 A1
(43) Pub. Date: Jun. 11, 2015

(54) METHOD FOR CURING SEALANT IN MANUFACTURING OF LIQUID CRYSTAL PANEL AND LIQUID CRYSTAL PANEL

(71) Applicants: Zhenghua Li, Shenzhen (CN); Ming Hung Shih, Shenzhen (CN)

(72) Inventors: Zhenghua Li, Shenzhen (CN); Ming Hung Shih, Shenzhen (CN)

(73) Assignee: Shenzhen China Star Optoelectronics Technology Co., Ltd., Shenzhen, Guangdong (CN)

(21) Appl. No.: 14/240,355

(22) PCT Filed: Jan. 23, 2014
(86) PCT No.: PCT/CN2014/071228

§ 371 Date: Feb. 21, 2014

(30) Foreign Application Priority Data
Dec. 5, 2013 (CN) 201310726177.5

(51) Int. Cl. G02F 1/1339; G02F 1/1335

(52) U.S. Cl. CPC G02F 1/1339; G02F 1/133514; G02F 1/133512

(57) ABSTRACT

The present disclosure proposes a method for curing a sealant in manufacturing of a liquid crystal panel. The liquid crystal panel includes an array substrate, a color filter substrate and a liquid crystal layer between the array substrate and the color filter substrate, a first film layer capable of blocking light is arranged on the side of the color filter substrate facing the liquid crystal layer, and a sealant is arranged between the array substrate and the color filter substrate outside the liquid crystal layer, and the method includes: step 1, removing a portion of the first film layer corresponding to the sealant; and step 2, applying UV from one side of the color filter substrate of the liquid crystal panel to irradiate the sealant, thus curing the sealant. The present disclosure also proposes a liquid crystal panel.

### FIELD OF THE INVENTION

The present disclosure relates to the field of manufacturing of liquid crystal panels, and particularly, relates to a method for curing a sealant in manufacturing of a liquid crystal panel and the liquid crystal panel.

### BACKGROUND OF THE INVENTION

In the manufacturing process of an existing liquid crystal display cell (LCD Cell), a sealant curing stage is generally performed in a manner of ultraviolet (UV) irradiation with a UV mask.

With reference to FIG. 1, UV 1 penetrates an array substrate 5 to irradiate on a sealant 3 so as to cure the same, and a UV mask 2 is configured to shield an Active Area (AA) zone to prevent the UV 1 from damaging a liquid crystal 7. Regarding to Polymer Stabilize Vertical Align (PSVA) liquid crystal, this solution has the disadvantage of early curing and sizing of a material in which a pre-tilt angle is formed.

In such a structure in the prior art, there is always a gray zone, which is defined as a zone between the edge of the sealant 3 facing a liquid crystal layer 7 and the corresponding outer edge of the liquid crystal layer 7. For the purpose that the sealant 3 is fully cured and the AA zone is completely free from irradiating by the UV 1, both the distance between the outer edge of the UV mask 2 and the inner edge of the sealant 3 and the distance a between the outer edge of the UV mask 2 and the corresponding outer edge of the AA zone should exceed a minimum. Under some conditions, for example, when a narrow frame is desired, the distance b between the AA zone and the sealant 3 may be gradually reduced to approach the aforementioned minimum or even smaller than the same. At this moment, the above-mentioned problems can not be solved by adopting a UV mask method. Moreover, the UV mask itself needs to be specially manufactured for different products and also needs accurate alignment in use, which brings non-ignorable expense on cost and manufacturing time.

In addition, to prevent affecting of the dark-state quality of the panel with back light leak, a black matrix (BM) 4 for shielding is generally arranged around the AA zone on the side of the color filter (CF) substrate 6. In addition, the width of the sealant 3 generally ranges from one to several millimeters, and the outer side of the sealant 3 and the edge of the CF substrate 6 should be spaced with a certain distance. The sealant 3 is generally disposed at a position overlapped with the BM 4 in the narrow frame design of a frame with merely several millimeters to save space. Thus, applicants design a method for curing a sealant in manufacturing of a liquid crystal panel and the corresponding liquid crystal panel, which solve the aforementioned problems.

### SUMMARY OF THE INVENTION

In the prior art, there are several defects. In the presence of a gray zone, for the purpose that a sealant may be fully cured and an AA zone is completely free from irradiation by the UV, the distance between the outer edge of a UV mask and the inner edge of the sealant and the distance between the outer edge of the UV mask and the corresponding outer edge of the AA zone should exceed a minimum. However, under some conditions, for example, when a narrow frame is desired, the distance between the AA zone and the sealant may be gradually reduced to approach the aforementioned minimum or even smaller than the minimum. At this moment, the above-mentioned problems can not be solved by adopting a UV mask method. Moreover, the UV mask itself needs to be specially manufactured for different products and also needs accurate alignment in use, which brings non-ignorable expense on cost and manufacturing time.

Thus, the present disclosure proposes a method for curing a sealant in manufacturing of a liquid crystal panel. In embodiment 1, the liquid crystal panel includes an array substrate, a color filter substrate and a liquid crystal layer between the array substrate and the color filter substrate, a first film layer capable of blocking light is arranged on the side of the color filter substrate facing the liquid crystal layer, and a sealant is arranged between the array substrate and the color filter substrate outside the liquid crystal layer, and the method includes: step 1, removing a portion of the first film layer corresponding to the sealant; and step 2, applying UV from one side of the color filter substrate of the liquid crystal panel to irradiate the sealant, thus curing the sealant.

In such a manner, both the distance between a black matrix and the sealant and the distance between the black matrix and the outer edge of the liquid crystal layer can meet the process requirements. Meanwhile, the distance between the sealant and the outer edge of the liquid crystal layer lies in the required range.

In embodiment 2 improved according to embodiment 1, in step 1, a shielding film layer is arranged on the side of the array substrate away from the liquid crystal layer, so that the shielding film layer can shield the leaked light due to said removing of the first film layer, and the shielding film layer is at least arranged at a zone corresponding to the sealant. Thus, the dark-state quality of the panel can be free from affecting by back light leak, as the latter is prevented effectively.

In embodiment 3 improved according to embodiment 1, a first metal layer is arranged on the surface of the array substrate facing the liquid crystal layer, and the method also includes step M: patterning the first metal layer, so that the first metal layer is provided with metal at a position corresponding to the removed zone in the first film layer, which zone corresponds to the sealant. Thus, light leak through the first film layer at the removed zone may be effectively blocked, and back light leak is prevented from affecting the dark-state quality of the panel.

In embodiment 4 improved according to embodiment 3, in step 1, the first metal layer and at least one second metal layer of a thin-film transistor on the array substrate are formed in the same film layer, and in step M, the at least one second metal layer on the array substrate is patterned at the same time, so that patterns of the second metal layer of the thin-film transistor of the array substrate and the corresponding first metal layer are formed at the same time. Thus, manufacturing procedures can be simplified, with reduced cost in time and material.

In embodiment 5 improved according to embodiment 3 or 4, the pattern of the first metal layer is configured to enable the first metal layer to be light-tight at least at the zone corresponding to the sealant. Thus, light leak through the first film layer at the removed zone may be effectively blocked, and back light leak is prevented from affecting the dark-state quality of the panel.

In embodiment 6 improved according to any of embodiments 3 to 5, the pattern of the first metal layer is configured to enable the first metal layer to be light-tight at least at the zone corresponding to the gray zone, wherein the gray zone is a zone between the edge of the sealant facing the liquid crystal layer and the corresponding outer edge of the liquid crystal layer.

In embodiment 7 improved according to any of embodiments 3 to 6, the pattern of the first metal layer is configured to enable the first metal layer to be light-tight from a position corresponding to the outer edge of the liquid crystal layer to the outer edge of the array substrate. In this way, light leak is better prevented.

At the zone of the array substrate corresponding to the sealant and the gray zone, the whole complete metal layer pattern is designed during mask design, and leaked light which may occur after the black matrix is partially removed is shielded by the original metal layer on the side of the array substrate close to the liquid crystal. In this way, the method is simpler and more economic compared with the method in the prior art.

The present disclosure also proposes a liquid crystal panel, including an array substrate, a color filter substrate and a liquid crystal layer between the array substrate and the color filter substrate, wherein a first film layer capable of blocking light is arranged on the side of the color filter substrate facing the liquid crystal layer, a sealant is arranged between the array substrate and the color filter substrate outside the liquid crystal layer, a portion of the first film layer corresponding to the sealant is removed, a first metal layer is arranged on the surface of the array substrate facing the liquid crystal layer, and the first metal layer is provided with metal at a position corresponding to the removed zone in the first film layer, which zone corresponds to the sealant.

Preferably, the first metal layer and at least one second metal layer of a thin-film transistor on the array substrate are formed in the same film layer. Thus, manufacturing procedures may be simplified, while waste of time and materials and the production cost can be both reduced.

More preferably, the pattern of the first metal layer is set to at least enable the first metal layer to be light-tight at the zone corresponding to the gray zone, wherein the gray zone is a zone between the edge of the sealant facing the liquid crystal layer and the corresponding outer edge of the liquid crystal layer. In this way, the leaked light can be effectively blocked.

The above-mentioned technical features may be combined in various technically feasible manners to generate new embodiments, as long as the objective of the present disclosure can be fulfilled.

### BRIEF DESCRIPTION OF THE DRAWINGS

The present disclosure will be described in more detail below based on merely nonfinite examples with reference to the accompanying drawings. Wherein:

FIG. 1 shows a schematic diagram of a method for curing a sealant in the prior art;

FIG. 2 shows a schematic diagram of a method for curing a sealant according to the present disclosure;

FIG. 3 shows an example of the method for curing the sealant according to the present disclosure;

FIG. 4 shows a preferred example of the method for curing the sealant according to the present disclosure.

In the drawings, the same components are indicated by the same reference signs. The accompanying drawings are not drawn in an actual scale.

### DETAILED DESCRIPTION OF THE EMBODIMENTS

The present disclosure will be introduced in detail below with reference to the accompanying drawings.

The present disclosure proposes a method for curing a sealant in manufacturing of a liquid crystal panel.

FIG. 2 shows a schematic diagram of a method for curing a sealant according to the present disclosure. With reference to FIG. 2, the liquid crystal panel includes an array substrate 25, a color filter substrate 26 and a liquid crystal layer 27 between the array substrate 25 and the color filter substrate 26, wherein a first film layer 24 capable of blocking light is arranged on the side of the color filter substrate 26 facing the liquid crystal layer 27, a first metal layer 28 is arranged on the surface of the array substrate 25 facing the liquid crystal layer 27, and a sealant 23 is arranged between the array substrate 25 and the color filter substrate 26 outside the liquid crystal layer 27. Wherein, the first film layer 24 includes a black matrix and a red, green and blue blocking film layer.

The method according to the present disclosure includes:

step (a), removing a portion of the first film layer 24 corresponding to the sealant 23;

step (b), applying UV 21 from one side of the color filter substrate 26 of the liquid crystal panel to irradiate the sealant 23, thus curing the sealant 23.

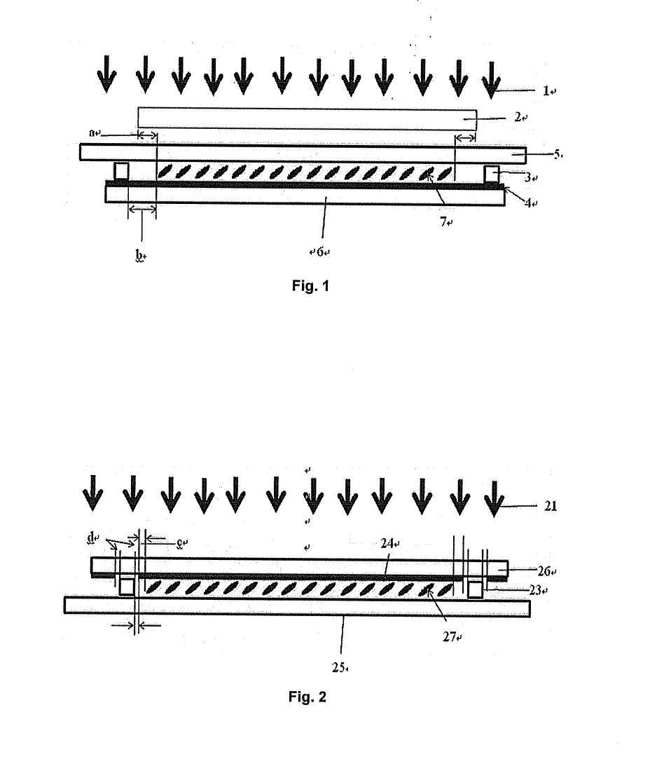

In an example, the black matrix on the color film substrate 26 side at a position where the sealant 23 is located is removed in advance. The color filter substrate 26 may face a light source of the UV 21 when the sealant 23 is cured, and the functions of a UV mask (with reference to FIG. 1) in the prior art are exerted by the black matrix and the red, green and blue blocking film layer on the color film substrate 26 side to block the UV 21 in an AA zone, thus, the sealant 23 may be cured without the UV mask.

With reference to FIG. 2, in such a manner, the distance d between the black matrix and the sealant 23 and the distance c between the black matrix and the outer edge of the liquid crystal layer can both meet the process requirements at the same time. Meanwhile, the distance between the sealant 23 and the outer edge of the liquid crystal layer also lies in the desired range.

The gap value of a liquid crystal cell is generally several microns, and the thickness of a glass substrate is hundreds of microns. In the LC panel in prior art shown in FIG. 1, the UV mask itself is spaced from the array substrate in a certain distance, whereas the first film layer 24 (such as a BM/RGB layer) serving as the UV mask is located at a position close to the liquid crystal layer 27 inside the color filter substrate 26. Therefore, it is not difficult to understand that a gray zone (a zone between the edge of the sealant 23 facing the liquid crystal layer 27 and the corresponding outer edge of the liquid crystal layer 27) at this moment may be reduced greatly compared with a gray zone (a zone between the edge of the sealant 3 facing the liquid crystal layer 7 and the corresponding outer edge of the liquid crystal layer 7) in the case that the UV mask is used in the prior art, thus the alignment precision can be greatly improved.

However, because the black matrix on one side of the color filter substrate 26 in a position corresponding to the sealant 23 needs to be removed, the probability of black light leak is increased, and appropriate measures should be adopted for repairing.

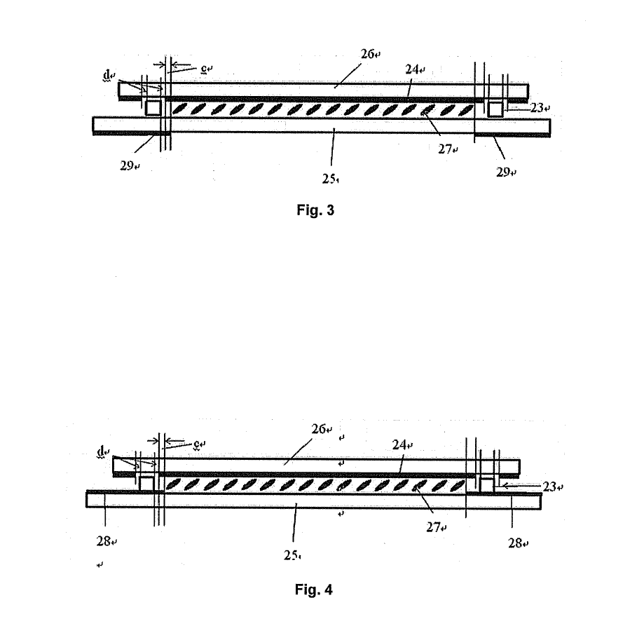

With reference to FIG. 3, in an example, in step 1, a shielding film layer 29 is arranged on the side of the array substrate 25 away from the liquid crystal layer 27, so that the shielding film layer 29 can shield the leaked light due to partially removing of the first film layer 24. Preferably, the shielding film layer 29 is at least arranged at a zone corresponding to the sealant 23.

With reference to FIG. 4, in another example, in step 1, a metal layer pattern is arranged in the first metal layer 28 on the surface of the array substrate 25 facing the liquid crystal layer 27, so that the first metal layer 28 can shield the leaked light due to partially removing of the first film layer 24.

In another example, the method according to the present disclosure also includes step M: patterning the first metal layer 28, so that the first metal layer 28 is provided with a metal at a position corresponding to the removed zone in the first film layer 24, which corresponds to the sealant 23.

Preferably, the first metal layer 28 and at least one second metal layer of a thin-film transistor on the array substrate 25 are formed in the same film layer, and in step M, the at least one second metal layer on the array substrate 25 is patterned at the same time, so that patterns of a second metal layer of the thin-film transistor of the array substrate 25 and the corresponding first metal layer 28 are formed at the same time.

Preferably, the pattern of the first metal layer 28 is configured to enable the first metal layer 28 to be light-tight at least at the zone corresponding to the sealant 23. More preferably, the pattern of the first metal layer 28 is configured to enable the first metal layer 28 to be light-tight at least at the zone corresponding to the gray zone, wherein the gray zone is a zone between the edge of the sealant 23 facing the liquid crystal layer 27 and the corresponding outer edge of the liquid crystal layer 27. Or alternatively, the pattern of the first metal layer 28 is configured to enable the first metal layer 28 to be light-tight from a position corresponding to the outer edge of the liquid crystal layer 27 to the outer edge of the array substrate 25.

According to the method of the present disclosure, in the zone of the array substrate 25 corresponding to the sealant 23 and the gray zone, the whole complete metal layer pattern is designed during mask design, and the leaked light which occurs after the black matrix is removed is shielded by the original metal layer on the side of the array substrate 25 close to the liquid crystal. Thus the method is simpler and more economic compared with the conventional method.

In the prior art, the sealant is cured by applying UV on the panel from the thin-film transistor (TFT) side, so the metal layer of the TFT side must be provided with a slit. At this moment, the panel is shielded on the color film substrate side by the black matrix, thus light in the curing zone can not leak through the liquid crystal cell. Whereas in the method for curing the sealant according to the present disclosure, light enters from the side of the color film substrate of the liquid crystal panel, and at this moment, the black matrix of the color film substrate side needs to be slit. If the metal layer of the TFT side corresponding to the curing zone is slit, the whole liquid crystal cell is euphotic at this position, because the black matrix (BM) has been removed for curing the sealant.

Due to actual wiring requirement, the first metal layer 28 is generally incomplete in the curing zone, where wires need to be specially designed to embody the specific metal layer pattern of the first metal layer 28 for shielding light.

The present disclosure also proposes a liquid crystal panel, including an array substrate 25, a color filter substrate 26 and a liquid crystal layer 27 between the array substrate 25 and the color filter substrate 26, wherein a first film layer 24 capable of blocking light is arranged on the side of the color filter substrate 26 facing the liquid crystal layer 27, a sealant 23 is arranged between the array substrate 25 and the color filter substrate 26 outside the liquid crystal layer 27, and the liquid crystal panel is characterized in that a portion of the first film layer 24 corresponding to the sealant 23 is removed, a first metal layer 28 is arranged on the surface of the array substrate 25 facing the liquid crystal layer 27, and the first metal layer 28 is provided with a metal at a position corresponding to the removed zone in the first film layer 24, which corresponds to the sealant 23. When UV 21 is applied from one side of the color filter substrate 26 of the liquid crystal panel to irradiate the sealant 23 for curing the same, the first metal layer 28 can shield the leaked light due to the partially removing of the first film layer 24.

Preferably, the first metal layer 28 and at least one second metal layer of a thin-film transistor on the array substrate 25 are formed in the same film layer.

Preferably, the pattern of the first metal layer 28 is configured to enable the first metal layer 28 to be light-tight at least at the zone corresponding to the gray zone, wherein the gray zone is a zone between the edge of the sealant 23 facing the liquid crystal layer 27 and the corresponding outer edge of the liquid crystal layer 27. In this way, the leaked light can be effectively blocked.

Although the present disclosure has been described with reference to the preferred examples, various modifications could be made to the present disclosure without departing from the scope of the present disclosure and components in the present disclosure could be substituted by equivalents. The present disclosure is not limited to the specific examples disclosed in the description, but includes all technical solutions falling into the scope of the claims.

1. A method for curing a sealant in manufacturing of a liquid crystal panel, wherein the liquid crystal panel includes an array substrate, a color filter substrate and a liquid crystal layer between the array substrate and the color filter substrate, a first film layer capable of blocking light is arranged on the side of the color filter substrate facing the liquid crystal layer, and a sealant is arranged between the array substrate and the color filter substrate outside the liquid crystal layer, and
the method includes: step (a), removing a portion of the first film layer corresponding to the sealant; and step (b), applying UV from one side of the color filter substrate of the liquid crystal panel to irradiate the sealant, thus curing the sealant.

2. The method according to claim 1, wherein a shielding film layer is arranged on the side of the array substrate away from the liquid crystal layer, so that the shielding film layer can shield the leaked light due to said removing of the first film layer, and the shielding film layer is at least arranged at a zone corresponding to the sealant.

3. The method according to claim 1, wherein a first metal layer is arranged on the surface of the array substrate facing the liquid crystal layer, and the method also includes step M: patterning the first metal layer, so that the first metal layer is provided with metal at a position corresponding to the removed zone in the first film layer, which zone corresponds to the sealant.

4. The method according to claim 3, wherein in step 1, the first metal layer and at least one second metal layer of a thin-film transistor on the array substrate are formed in the same film layer, and in step M, the at least one second metal layer on the array substrate is patterned at the same time, so that patterns of the second metal layer of the thin-film transistor of the array substrate and the corresponding first metal layer are formed at the same time.

5. The method according to claim 3, wherein the pattern of the first metal layer is configured to enable the first metal layer to be light-tight at least at the zone corresponding to the sealant.

6. The method according to claim 3, wherein the pattern of the first metal layer is configured to enable the first metal layer to be light-tight at least at the zone corresponding to the gray zone, wherein the gray zone is a zone between the edge of the sealant facing the liquid crystal layer and the corresponding outer edge of the liquid crystal layer.

7. The method according to claim 4, wherein the pattern of the first metal layer is configured to enable the first metal layer to be light-tight at least at the zone corresponding to the gray zone, wherein the gray zone is a zone between the edge of the sealant facing the liquid crystal layer and the corresponding outer edge of the liquid crystal layer.

8. The method according to claim 5, wherein the pattern of the first metal layer is configured to enable the first metal layer to be light-tight at least at the zone corresponding to the gray zone, wherein the gray zone is a zone between the edge of the sealant facing the liquid crystal layer and the corresponding outer edge of the liquid crystal layer.

9. The method according to claim 3, wherein the pattern of the first metal layer is configured to enable the first metal layer to be light-tight from a position corresponding to the outer edge of the liquid crystal layer to the outer edge of the array substrate.

10. The method according to claim 4, wherein the pattern of the first metal layer is configured to enable the first metal layer to be light-tight from a position corresponding to the outer edge of the liquid crystal layer to the outer edge of the array substrate.

11. The method according to claim 5, wherein the pattern of the first metal layer is configured to enable the first metal layer to be light-tight from a position corresponding to the outer edge of the liquid crystal layer to the outer edge of the array substrate.

12. A liquid crystal panel, including an array substrate, a color filter substrate and a liquid crystal layer between the array substrate and the color filter substrate, wherein a first film layer capable of blocking light is arranged on the side of the color filter substrate facing the liquid crystal layer, a sealant is arranged between the array substrate and the color filter substrate outside the liquid crystal layer, a portion of the first film layer corresponding to the sealant is removed, a first metal layer is arranged on the surface of the array substrate facing the liquid crystal layer, and the first metal layer is provided with metal at a position corresponding to the removed zone in the first film layer, which zone corresponds to the sealant.

13. The liquid crystal panel according to claim 12, wherein the first metal layer and at least one second metal layer of a thin-film transistor on the array substrate are formed in the same film layer.

14. The liquid crystal panel according to claim 12, wherein the pattern of the first metal layer is configured to enable the first metal layer to be light-tight at least at the zone corresponding to the gray zone, wherein the gray zone is a zone between the edge of the sealant facing the liquid crystal layer and the corresponding outer edge of the liquid crystal layer.

15. The liquid crystal panel according to claim 13, wherein the pattern of the first metal layer is configured to enable the first metal layer to be light-tight at least at the zone corresponding to the gray zone, wherein the gray zone is a zone between the edge of the sealant facing the liquid crystal layer and the corresponding outer edge of the liquid crystal layer.
